(19) United States
(12) Patent Application Publication
(10) Pub. No.: US 2012/0090195 A1
(43) Pub. Date: Apr. 19, 2012

(54) APPARATUS AND METHOD FOR HEATING ELECTRONIC COMPONENT

(75) Inventors: Mitsuo TAKEUCHI, Kawasaki (JP); Tohru Harada, Kawasaki (JP); Toru Okada, Kawasaki (JP)

(73) Assignee: FUJITSU LIMITED, Kawasaki-shi (JP)

(21) Appl. No.: 13/232,655

(22) Filed: Sep. 14, 2011

(30) Foreign Application Priority Data
Oct. 15, 2010 (JP) 2010-233083

(51) Int. Cl. F26B 3/02; F26B 25/08

(52) U.S. Cl. 34/487; 34/237

(57) ABSTRACT

An apparatus for heating an electronic component, the apparatus includes a table on which a printed board is placed, a heating head having a contact surface that comes into contact with the upper surface of a rectangular electronic component mounted on the upper surface of the printed board, a discharge portion that jets heated air; and a first passage that guides the air discharged from the discharge portion to the four vertexes of the electronic component.

### CROSS-REFERENCE TO RELATED APPLICATION

This application is based upon and claims the benefit of priority from the prior Japanese Patent Application No. 2010-233083 filed on Oct. 15, 2010, the entire contents of which are incorporated herein by reference.

### FIELD

The embodiments disclosed herein are relates to an apparatus and a method for heating an electronic component.

### BACKGROUND

Recent common electronic components, such as ICs and LSIs, mounted on printed boards are of a ball grid array (BGA) type. The BGA is configured such that a large number of terminals are arranged in matrix form on the lower surface of an electronic component, and the individual terminals are provided with hemispherical soldering materials. This BGA-type electronic component is mounted by heating the entire printed board including the electronic component.

Recent printed boards tend to increase in the packaging density of electronic components, thus decreasing in space among the electronic components. If an electronic component mounted on a printed board has a defect etc., a repair work of removing the electronic component from the printed board is performed. Examples of a heating method for dismounting the electronic component from the printed board at the repair work include a method of blowing hot air and a method of bringing a heater into contact with the electronic component. Japanese Laid-open Patent Publication Nos. 2003-258026, 10-32384, 2009-141012 and 2006-286798 are examples of related art.

### SUMMARY

According to an aspect of the embodiment, an apparatus for heating an electronic component, the apparatus includes a table on which a printed board is placed, a heating head having a contact surface that comes into contact with the upper surface of a rectangular electronic component mounted on the upper surface of the printed board, a discharge portion that jets heated air; and a first passage that guides the air discharged from the discharge portion to the four vertexes of the electronic component.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a perspective view of a head of an electronic-component heating apparatus according to an embodiment (Part 1);

FIG. 2 is a perspective view of the head of the electronic-component heating apparatus according to the embodiment (Part 2);

FIG. 3 is a schematic diagram illustrating the air passages of the electronic-component heating apparatus according to the embodiment;

FIG. 4 is a partially sectional side view illustrating the air passages of the electronic-component heating apparatus according to the embodiment;

FIG. 5 is a cross-sectional view of the electronic-component heating apparatus according to the embodiment, illustrating the air passages;

FIG. 6 is a perspective view illustrating the air passages of the electronic-component heating apparatus according to the embodiment;

FIG. 7A is a side view illustrating a repair process;

FIG. 7B is a side view illustrating the repair process;

FIG. 7C is a side view illustrating the repair process;

FIG. 7D is a side view illustrating the repair process;

FIG. 7E is a side view illustrating the repair process;

FIG. 8 is a diagram illustrating a temperature distribution on the electronic component using the electronic-component heating apparatus according to the embodiment;

FIG. 9 is a side view illustrating another configuration example of the electronic-component heating apparatus according to the embodiment; and

FIG. 10 is a flowchart illustrating the process of heating an electronic component according to the embodiment.

### DESCRIPTION OF EMBODIMENTS

Preferred embodiments of the disclosed technology will be described in detail herein below with reference to the drawings. The following description is an example a repair work of removing an electronic component from a printed board using an electronic-component heating apparatus.

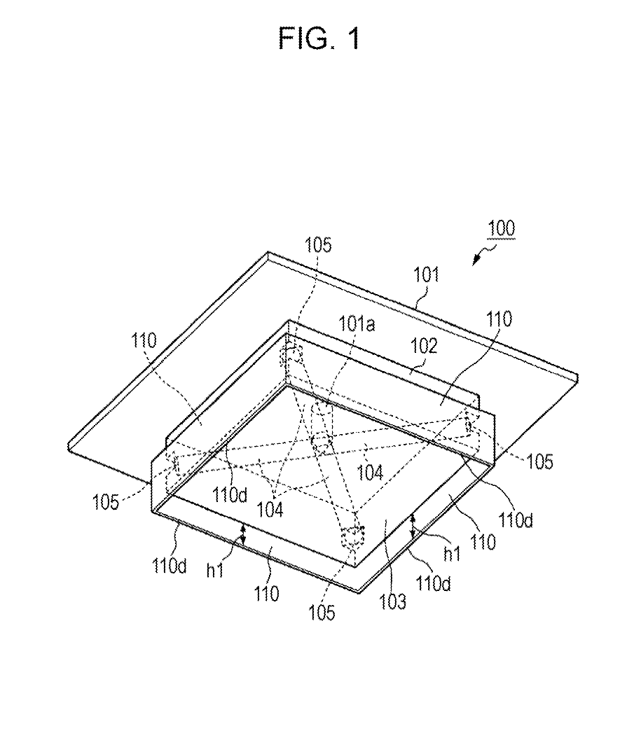

FIG. 1 is a perspective view of a head of an electronic-component heating apparatus according to an embodiment. FIG. 1 is a diagram of a head 100 as viewed from the bottom. FIG. 1 mainly illustrates air passages. The outline of the head 100 will first be described using FIG. 1. The head 100 is formed by cutting a metal material with high thermal conductivity. A heating head 102 is provided under a top plate 101. The heating head 102 accommodates a heater (not illustrated) serving as a heat source and has a predetermined height.

The lower surface of the heating head 102 serves as a contact surface 103 that comes into contact with the upper surface of an electronic component to be mounted (not illustrated). The contact surface 103 has a rectangular shape having a width and length corresponding to the shape (width and length) of the electronic component. The heating head 102 has therein air passages 104.

The central position of the top plate 101 has an air intake portion 101a opened at one place, which guides air downward into the heating head 102. The heating head 102 has therein the passages 104 having the same length from the central position toward the four vertexes (four corners). As illustrated in the drawing, the passages 104 are distributed in a radial pattern from the central position of the heating head 102 toward discharge ports 105. The heater heats the air while passing through the passages 104, and the heated air is blown out through the discharge ports 105. The air is fed from the outside to the intake portion 101a by blowing means (not illustrated).

Outer walls 110 are provided along the four sides of the heating head 102. The outer walls 110 are formed of four metal plates (the details will be described later) and are attached to the heating head 102 in a state in which they protrude a predetermined height h1 downward from the contact surface 103 of the heating head 102. The bottom surfaces 110d of the outer walls 110 may meet the upper surface of the printed board on which the electronic component is mounted. The height h1 is set so that the bottom surfaces 110d of the outer walls 110 push the soldering materials of a BGA formed on the lower surface of the electronic component when meeting the upper surface of the electronic component. The setting may be performed by adjusting the mounting height of the outer walls 110 relative to the heating head 102. The outer walls 110 prevent the heated air discharged from the discharge ports 105 from being blown to adjacent electronic components other than the desired component (the electronic component to be dismounted).

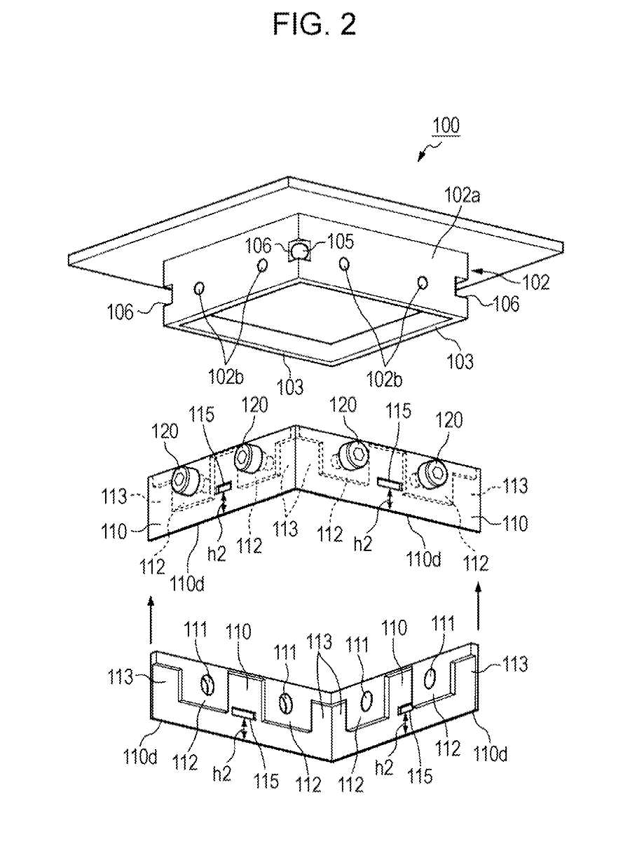

Next, a structure for blowing the heated air out from between the discharge ports 105 and the outer walls 110 and the structure of the passages 104 of the air that is finally exhausted outward from the outer walls 110 will be described herein below. FIG. 2 is a perspective view of the head 100 of the electronic-component heating apparatus according to the embodiment. FIG. 2 illustrates a state in which the four outer walls 110 illustrated in FIG. 1 are detached. FIG. 2 illustrates the components in more detail than the schematic diagram of FIG. 1.

First, the structure of the discharge ports 105 described with reference to FIG. 2. The discharge ports 105 are open at the four vertexes of the heating head 102. The individual discharge ports 105 have level difference portions 106 perpendicular to the passages 104. Owing to the level difference portions 106, positions at which the level difference portions 106 are open are located closer the center of the heating head 102 from the four vertexes. Thus, the heated air blown out through the discharge ports 105 is not blown out in dotted form from the four vertexes but is blown out with a predetermined width from the level difference portions 106.

The outer walls 110 are composed of four metal plates having a length corresponding to each of the four sides of the heating head 102. The outer walls 110 are attached to the side walls 102a of the heating head 102 by screwing screws 120 into screw holes 102b formed in the side walls 102a. Therefore, the individual outer walls 110 have screw holes 111 through which the screws 120 pass. The screw holes 111 are long holes that are long in the vertical direction to adjust the mounting position (vertical direction) of the outer walls 110 relative to the heating head 102.

The inner surface of the outer walls 110, that is, the surface in contact with the heating head 102, is provided with protruding portions 112 formed by increasing the plate thickness of the outer walls 110. The protruding portions 112 are formed in substantially L-shape. Owing to the protruding portions 112, straight discharge grooves 113 are formed between the level difference portions 106 of the heating head 102 and the outer walls 110. The discharge grooves 113 are formed downward. Thus, the heated air discharged through the discharge ports 105 passes a gap formed between the level difference portions 106 and the discharge grooves 113 and is blown out from the four vertexes of the heating head 102 (the flow of the air will be described later in detail).

Furthermore, the central portions of the outer wall 110 have air exhaust ports 115 opened at a predetermined height h2 from the bottom surfaces 110d of the outer walls 110. The predetermined height h2 is set to be higher than the height of the other adjacent electronic components mounted on the printed board when the bottom surfaces 110d of the outer walls 110 meet the printed board. Thus, the heated air after enclosed by the lower surface (contact surface 103) of the heating head 102 and the four outer walls 110 and blown to the electronic component is exhausted outside through the air exhaust ports 115 and rises immediately. This may prevent the heated air from blowing onto the adjacent other electronic components, thereby preventing unnecessarily heating the adjacent other electronic components.

Although the outer walls 110 described above have a four-piece structure divided in correspondence with the four sides of the heating head 102, they may be formed of two L-shaped plates or one plate shaped in a rectangle in advance. With the structure of the four outer walls 110, the heights of the individual four sides may be adjusted accurately.

As illustrated in FIG. 2, the contact surface 103 is formed in a square ring shape having a predetermined width and meets only the outer periphery of the electronic component. This allows the heating head 102 to heat the electronic component from the outer periphery with which the contact surface 103 comes into contact.

Passage of Heated Air

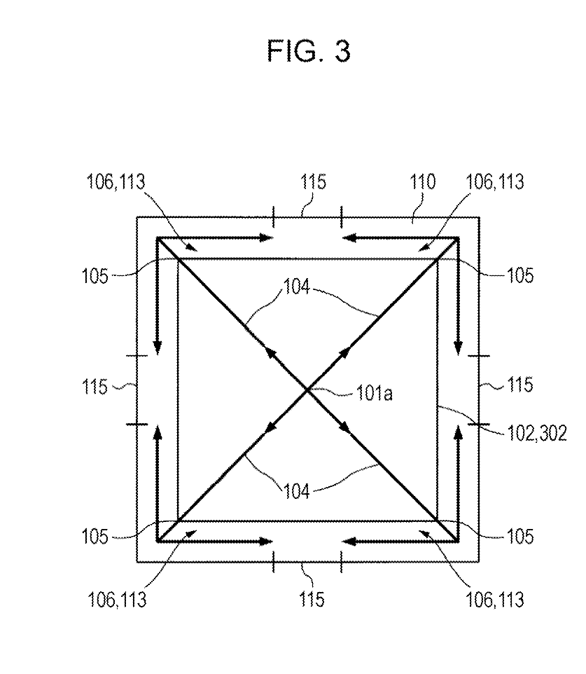

FIG. 3 is a schematic diagram illustrating the air passages of the electronic-component heating apparatus according to the embodiment. The size of the heating head 102 is substantially the same as that of the electronic component as viewed from the top. The airflow is indicated by the thick arrow (→). The air taken in the central position of the heating head 102 through the intake portion 101a is separated into four directions by the passages 104.

The heater in the heating head 102 heats the air mainly while passing through the passages 104. The heated air flows in the passages 104 having the same length to the four corners (four vertexes) of the heating head 102 and is discharge through the discharge ports 105. At that time, the air is discharged from the gap between the level difference portions 106 formed at the discharge ports 105 and the discharge grooves 113 formed on the outer walls 110 to heat the four vertexes of the electronic component.

Furthermore, the heated air discharged from the discharge ports 105 blows onto the outer walls 110 that cover the four sides of the heating head 102. And the heated air flows along the sides of the outer walls 110 to heat the side (outer periphery) of an electronic component 302 and the soldering materials at the side (outer periphery) of the electronic component 302. The heated air is finally exhausted from the air exhaust ports 115 provided in the outer walls 110.

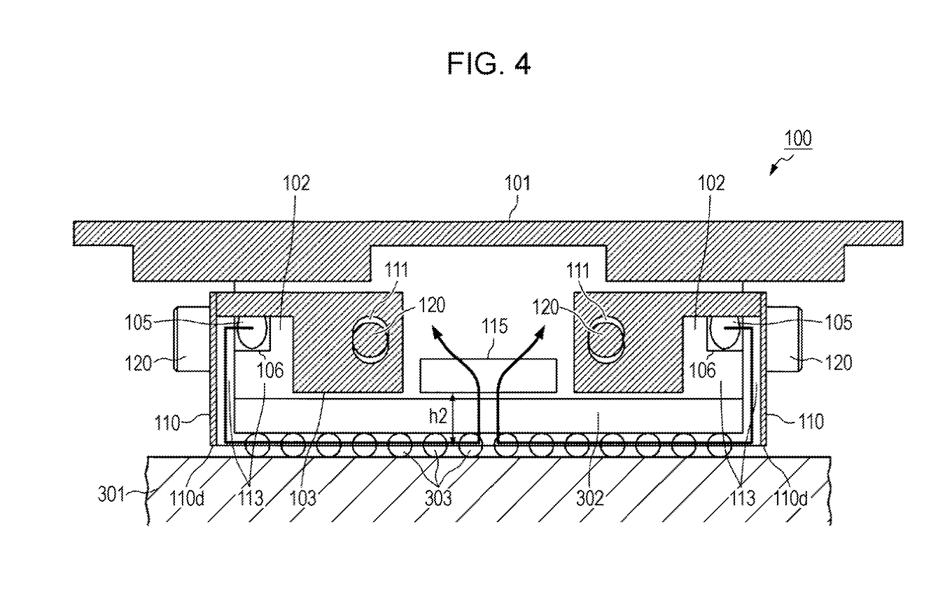

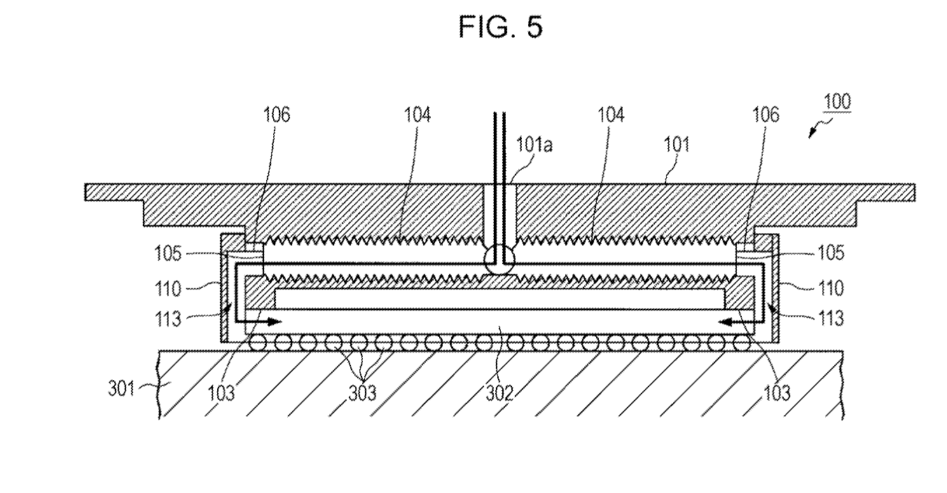

The air passages 104 are described in more detail. FIG. 4 is a partially sectional side view illustrating the air passages of the electronic-component heating apparatus according to the embodiment. FIG. 4 illustrates a cross-sectional view of the electronic-component heating apparatus cut at the protruding portions 112 of the outer walls 110. FIG. 5 is a cross-sectional view of the electronic-component heating apparatus according to this embodiment, illustrating the air passages. FIG. 5 illustrates a state in which the entire head 100 is cut diagonally along the passage 104.

FIGS. 4 and 5 illustrate a printed board 301 placed on a table and the electronic component 302. The lower surface of the electronic component 302 is provided with BGA soldering materials (in the drawing, round shaped for the sake of convenience) 303 at individual electrode positions, which are bonded to the corresponding electrodes of the printed board 301.

As illustrated in FIG. 5, the air taken from the intake portion 101a of the head 100 into the central position of the heating head 102 is separated into four directions by the four passages 104. The surfaces of the cross sections of the individual passages 104 are made rough to increase the surface area that meets the air. Thus, the air may be efficiently heated by the heater in the heating head 102 while passing through the passages 104. The rough surfaces of the passages 104 may be formed by cutting internal threads by tapping from the discharge ports 105 side of the heating head 102.

As illustrated in FIG. 5, the air discharged from the discharge ports 105 is discharged from the gap between the level difference portions 106 formed at the discharge ports 105 and the discharge grooves 113 formed on the outer walls 110 to heat the four vertexes of the electronic component 302. This allows the electronic component 302 to be heated from the four corners (four vertexes). Thereafter, as illustrated in FIG. 4, the heated air discharged from the discharge ports 105 blows onto the outer walls 110 that cover the four sides of the heating head 102. And the heated air flows along the sides of the outer walls 110 to heat the side (outer periphery) of the electronic component 302 and the soldering materials on the side (outer periphery) of the electronic component 302. Finally, the heated air is exhausted from the air exhaust ports 115 provided in the outer walls 110.

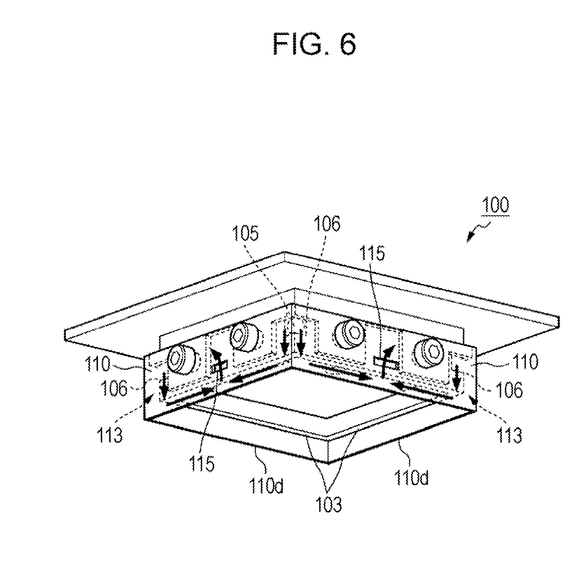

FIG. 6 is a perspective view illustrating the air passages of the electronic-component heating apparatus according to the embodiment. The air passages viewed from the components illustrated in FIGS. 3 to 5 are also illustrated in the perspective view of FIG. 6. In FIG.6, the heated air that has blown out from the four corners (four vertexes) of the heating head 102 flows along the sides of the outer walls 110 and is exhausted from the air exhaust ports 115.

Repair Process

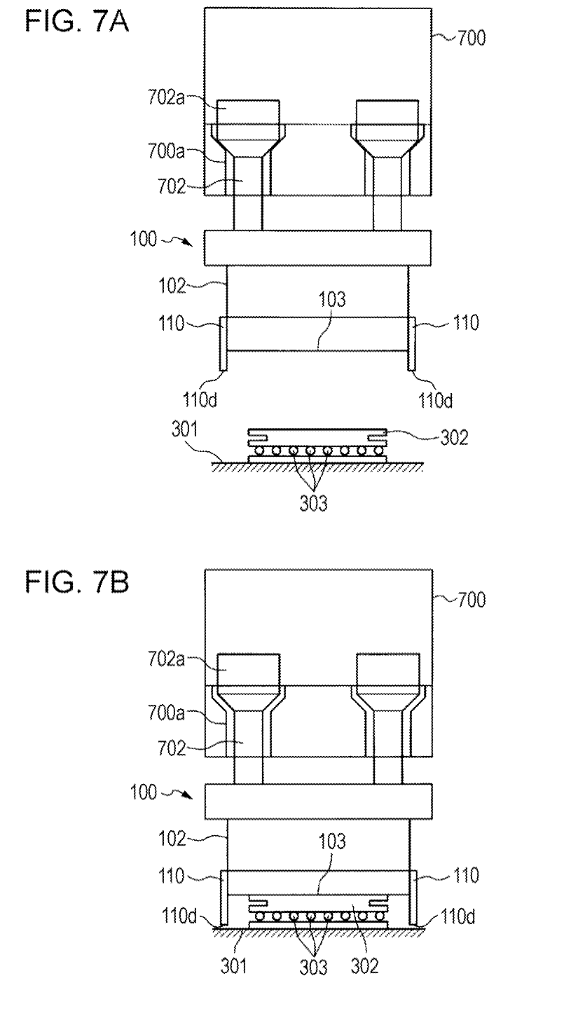

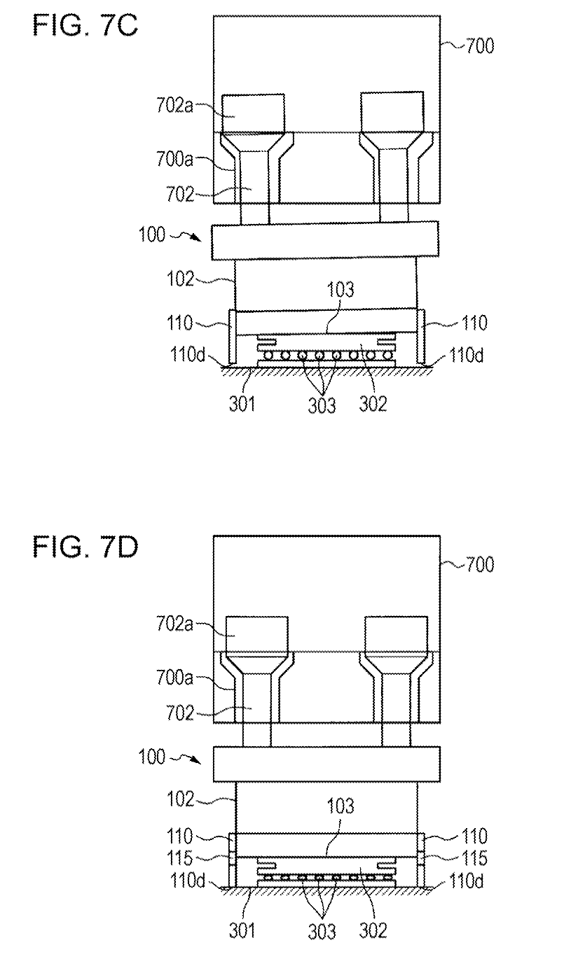

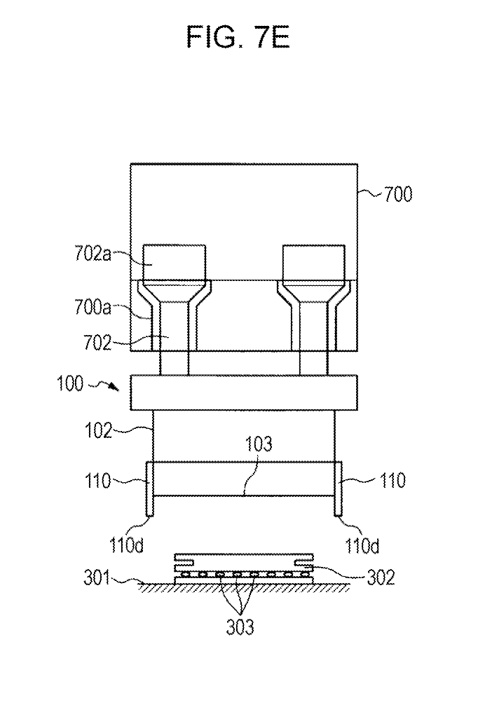

Next, the process of repairing the printed board 301 will be described. FIGS. 7A to 7E are side views illustrating the repair process. As illustrated in the drawings, the head 100 is provided under a driving unit 700 that moves up and down relative to the printed board 301 placed on the table. The head 100 is provided with a plurality of support arms 702 on the upper surface thereof. The support arms 702 are fitted in support grooves 700a that are open in the driving unit 700. The upper ends 702a of the support arms 702 are wide collars, which prevent the support arms 702 from dropping off from the support grooves 700a.

First, as illustrated in FIG. 7A, the driving unit 700 is located above the desired electronic component 302 to be dismounted from among the electronic components mounted on the printed board 301.

Next, as illustrated in FIG. 7B, the driving unit 700 is moved downward to bring the contact surface 103 of the heating head 102 into contact with the upper surface of the electronic component 302. On detection that the contact surface 103 has met the upper surface of the electronic component 302, the heater provided in the heating head 102 is energized to start heating. As illustrated in the drawing, in the state in which the contact surface 103 of the heating head 102 is in contact with the upper surface of the electronic component 302, the bottom surfaces 110d of the outer walls 110 are not in contact with the upper surface of the printed board 301.

The space (gap) between the bottom surfaces 110d of the outer walls 110 and the upper surface of the printed board 301 is, for example, 100 μm. The gap is so narrow that most of the heated air is exhausted from the air exhaust ports 115. Since the height of the air exhaust ports 115 is set higher than that of the adjacent other electronic components, the heated air exhausted from the air exhaust ports 115 does not unnecessarily heat the adjacent other electronic components.

The driving unit 700 is controlled so that the contact surface 103 of the heating head 102 is stopped at a slightly lower position after coming into contact with the upper surface of the electronic component 302. The support arms 702 may move freely in the support grooves 700a. In this state, the weight of the heating head 102 is applied to the upper surface of the electronic component 302. By heating the heating head 102, the electronic component 302 is heated via the contact surface 103. As illustrated in FIG. 7B, the contact surface 103 is in contact with the outer periphery of the electronic component 302, so that the electronic component 302 is heated from the outer periphery.

Furthermore, when the heating head 102 has reached a predetermined temperature (for example, 200° C.) halfway through temperature rising, air is taken in the head 100. As described with reference to FIGS. 3 to 6, the air is taken in from the intake portion 101a of the head 100, is heated while passing through the passages 104, and is blown out from the four corners (four vertexes) of the heating head 102. Thus, the heated air is first blown to the four corners (four vertexes) of the electronic component 302.

This allows the electronic component 302 to be heated from the four vertexes. Thereafter, the heated air flows along the outer walls 110 to heat the electronic component 302 from the side (for the passages 104, see FIGS. 3 to 6). While the heating head 102 is heated, the self-weight of the head 100 is applied onto the electronic component 302. Therefore, as illustrated in FIG. 7C, when the printed board 301 is deformed during heating, the head 100 vibrates following the deformation.

Thereafter, as illustrated in FIG. 7D, the heating head 102 heats the electronic component 302 at a predetermined temperature (for example, 280° C.) and continues to heat the air, the BGA soldering materials 303 provided on the bottom surface of the electronic component 302 reaches a melting temperature (for example, 230° C.). As illustrated in FIG. 7B, the time after the contact surface 103 of the heating head 102 comes into contact with the electronic component 302 until the soldering materials 303 melt, as illustrated in FIG. 7D, is, for example, eight minutes. Since the soldering materials 303 melt, the bottom surfaces 110d of the outer walls 110 provided around the heating head 102 come into contact with the upper surface of the printed board 301. In this state, the heating head 102 needs not to excessively crush down the soldering materials 303, and thus, the vertical position of the outer walls 110 is adjusted in advance when attached to the heating head 102 (see FIG. 2).

After the bottom surfaces 110d of the outer walls 110 meet the upper surface of the printed board 301, the heated air blown onto the electronic component 302 is exhausted from the air exhaust ports 115 of the outer walls 110. Although described above, setting the height of the air exhaust ports 115 higher than the height of the adjacent other electronic components may prevent the heated air exhausted from the air exhaust ports 115 from unnecessarily heating the adjacent other electronic components (see FIG. 2).

Thereafter, as illustrated in FIG. 7E, the driving unit 700 moves the head 100 upward. The control unit of the driving unit 700 detects displacement of the head 100 due to the melting of the soldering materials 303 by measuring the melting time of the soldering materials 303 (for example, eight minutes as described above) or with a displacement sensor, such as a strain gauge, provided at the driving unit 700. Thereafter, the heating with the heater in the heating head 102 is stopped to decrease the temperature of the heating head 102. Thus, the heating to the supplied air is stopped, and thus, the temperature of the air decreases. At the point where the temperature of the electronic component 302 has decreased to a predetermined temperature, the driving unit 700 moves the head 100 upward, and the repair is completed.

Although FIG. 7E illustrates a state in which the electronic component 302 is mounted on the printed board 301, it may be dismounted using a jig. Alternatively, the head 100 may be provided with an intake port that vertically passes there through to reach the upper surface of the electronic component 302. And the electronic component 302 may be attracted through the intake port when the head 100 is moved upward, as illustrated in FIG. 7E, to allow the electronic component 302 to be dismounted from the printed board 301.

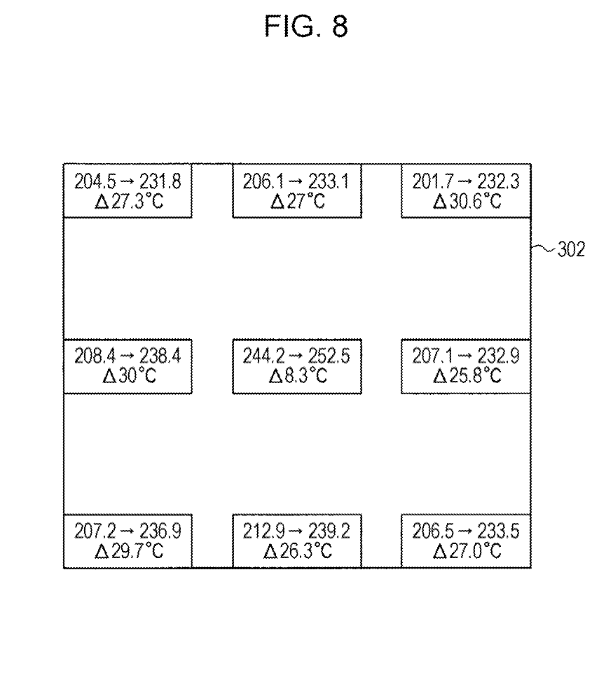

FIG. 8 is a diagram illustrating a temperature distribution on the electronic component 302 using the electronic-component heating apparatus according to the embodiment. The temperatures on individual portions of the electronic component 302 as viewed from the top were measured. The objects to be compared are the configuration in which heated air is blown to the four corners (four vertexes) of the electronic component 302, described in the forgoing embodiment, and a configuration in which heated air is simply blown onto the upper surface of the electronic component 302 (related art).

As illustrated in the drawing, in the related art, for example, the temperature at the upper left of the four vertexes of the electronic component 302 was 204.5° C., while in the embodiment; it may be increased to 231.8° C. The temperature at the center of the electronic component 302 and the temperature at the corner were compared. In the related art, the temperature at the center was 244.2° C. and the temperature at the upper left was 204.5° C., which illustrates a temperature difference of 39.7° C. In contrast, in the embodiment, the temperature at the center was 252.5° C. and the temperature at the upper left was 231.8° C., which illustrates that the temperature difference may be reduced to 20.7° C. In the foregoing embodiment, the temperature difference may be reduced not only at the upper left but also at the other vertexes and the sides.

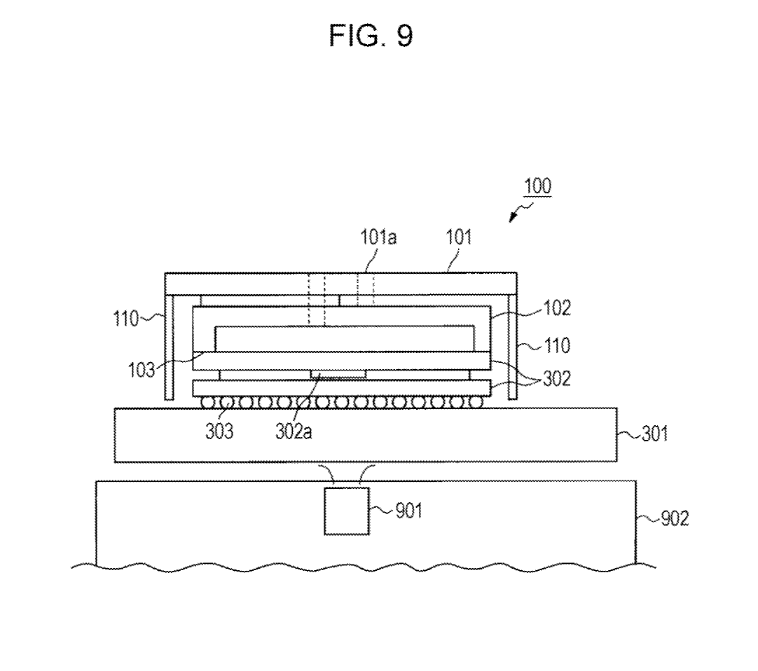

FIG. 9 is a side view illustrating another configuration example of the electronic-component heating apparatus according to this embodiment. Also illustrated in FIG. 8, the electronic component 302 has a tendency to increase in temperature most at the center where a core 302a with high thermal conductivity is provided. Therefore, in addition to the configuration of the foregoing embodiment, a cooling unit 901 may be provided to cool the central portion of the electronic component 302 from the lower surface of the printed board 301. Reference sign 902 denotes a heater that heats the entire printed board 301. The cooling unit 901 blows cooling air from a portion of the lower surface of the printed board 301 located at the central portion of the electronic component 302. This allows the central portion of the electronic component 302 to be cooled during heating of the electronic component 302, thus allowing the entire electronic component 302 to be uniformly heated.

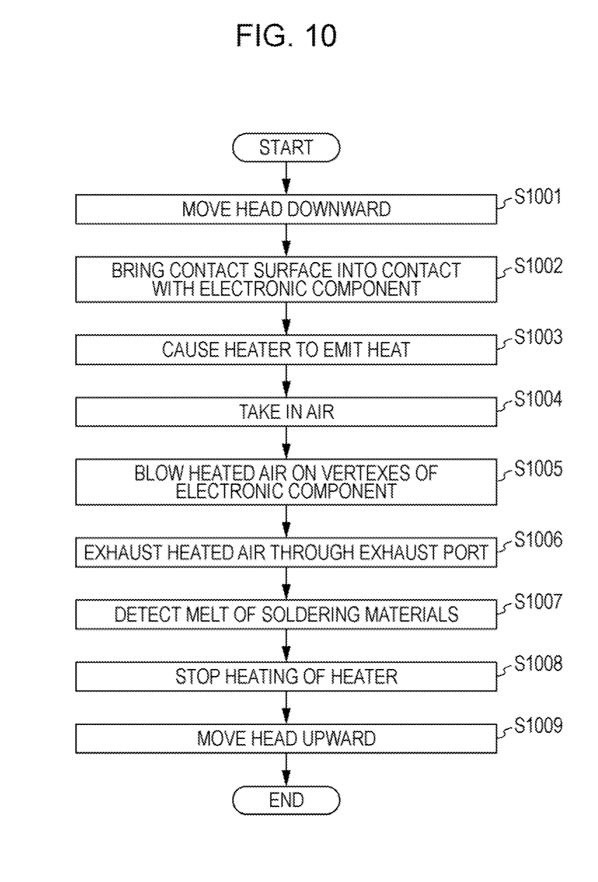

FIG. 10 is a flowchart illustrating the process of heating an electronic component according to the embodiment. First, the control unit (not illustrated) moves the head 100 downward using the driving unit 700 (step S1001). Thus, the contact surface 103 of the heating head 102 is brought into contact with the upper surface of the electronic component 302 (step S1002). Thereafter, the control unit detects that the contact surface 103 has met the upper surface of the electronic component 302 and causes the heater provided in the heating head 102 to emit heat (step S1003).

Thereafter, when the heating head 102 has reached a predetermined temperature (for example, 200° C.) halfway through temperature rising, air is taken in the head 100 (step S1004). The air is taken in from the intake portion 101a of the head 100 and is heated while passing through the passages 104. The heated air is blown to the vertexes of the electronic component 302 (step S1005). The heated air blown to the electronic component 302 is exhausted from the air exhaust ports 115 of the outer walls 110 (step S1006).

Thereafter, the control unit of the driving unit 700 measures the melting time of the soldering materials 303 (for example, eight minutes as described above) or, alternatively, detects displacement of the head 100 due to the melting of the soldering materials 303 using the displacement sensor, such as a strain gauge, provided at the driving unit 700 (step S1007). Thus, the heating with the heater in the heating head 102 is stopped (step S1008) to decrease the temperature of the heating head 102. Thus, the heating to the supplied air is stopped, and thus, the temperature of the air decreases. At the point where the temperature of the electronic component 302 has decreased to a predetermined temperature, the driving unit 700 moves the head 100 upward (step S1009), and the repair is completed.

A rectangular electronic component tends to decrease in temperature at the four corners (four vertexes) more than at the other portions. However, according to the embodiment described above, by blowing heated air first to the vertexes, the entire electronic component may be uniformly heated, thus facilitating the repair work.

Furthermore, the configuration in which the air is heated using the heater of the heating head eliminates the need for using another heating means for heating the air, thus allowing heating with the heater and air to be performed with a simple structure.

Furthermore, since the heating head has substantially the same size as that of the upper surface of the electronic component and is simply provided with plate-like outer walls along the four sides of the heating head. The size including the outer walls is about 2 mm larger than the size of the electronic component, which allows only a desired electronic component to be repaired even for a printed board on which electronic components are disposed at small intervals.

Although the foregoing embodiment is described taking the process of dismounting an electronic component as an example, the electronic-component heating apparatus may also be applied to the process of mounting the electronic component thereafter. In other words, when a desired electronic component 302 is to be independently mounted on the printed board 301, the corners (vertexes) of the electronic component 302 may be heated to substantially the same temperature as that of the other portions. Therefore, the entire soldering materials 303 on the lower surface of the electronic component 302 may be bonded to the printed board 301 at a uniform temperature.

As described above, according to the apparatus and method for heating an electronic component, only a desired electronic component on a printed board may be uniformly heated using hot air without unnecessarily heating adjacent other electronic components, which may be achieved with a simple structure and manufacturing method.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An apparatus for heating an electronic component, the apparatus comprising:
a table on which a printed board is placed;
a heating head having a contact surface that comes into contact with a first upper surface of a rectangular electronic component mounted on a second upper surface of the printed board;
a discharge portion that jets heated air; and
a first passage that guides the air discharged from the discharge portion to the four vertexes of the electronic component.

2. The apparatus according to claim 1, further comprising
an outer wall with a predetermined height which is provided along the heating head and which protrudes toward the printed board to define the first passage.

3. The apparatus according to claim 2, further comprising
an air exhaust port at the central portion of each of the outer walls, wherein
a second passage for guiding the air that has reached the four vertexes of the electronic component to the air exhaust port is defined by the outer walls.

4. The apparatus according to claim 3, wherein
the air exhaust port is open at a position higher than the adjacent other electronic components on the printed board.

5. The apparatus according to claim 2, wherein
the outer wall is shaped like a plate and is attached to the individual sides of the heating head, and the attaching positions adjusted with respect to the sides of the heating head.

6. The apparatus according to claim 1, wherein
the heating head includes;
a heater serving as a heat source;
an intake portion for the air;
the discharge portion that is open in the heating head; and
a third passage that heats the air taken in from the intake portion using the heater and guides the heated air to the discharge portion.

7. The apparatus according to claim 6, wherein
the third passage is processed so as to have a rough surface in the heating head.

8. The apparatus according to claim 6, wherein
the intake portion is provided at one location at the center of the heating head; and
the third passage has the same length as the radial length from the intake portion to the discharge portion.

9. The apparatus according to claim 1, wherein
the contact surface of the heating head is formed in a square ring shape along the outer periphery of the heating head.

10. The apparatus according to claim 1, further comprising
a cooling unit which is located in correspondence with a portion that becomes hot when the electronic component is heated and which cools the electronic component from the back of the printed board.

11. A method for heating an electronic component, the method comprising:
bringing the contact surface of a heating head into contact with a upper surface of a rectangular electronic component mounted on a printed board;
heating the heating head; and
discharging heated air to the four vertexes of the electronic component.
